(19) United States
(12) Patent Application Publication
(10) Pub. No.: US 2024/0289572 A1
(43) Pub. Date: Aug. 29, 2024

(54) FORKLIFT-BASED SCANNER

(71) Applicant: Kargo Technologies Corporation, San Francisco, CA (US)

(72) Inventors: Jeffrey Michael Quackenbush, San Francisco, CA (US); Alva Edward Mckay, San Francisco, CA (US); Rodrigo Barriuso de Juan, San Francisco, CA (US); Charles Harrison Wood, San Francisco, CA (US); Bingyan Liu, Mountain View, CA (US); Nicholas Jialei Su, San Francisco, CA (US); Joshua David Adams, San Jose, CA (US); Joshua Gabriel Guggenheim, San Francisco, CA (US); John Gleeson Strizich, San Francisco, CA (US)

(21) Appl. No.: 18/589,403

(22) Filed: Feb. 27, 2024

Related U.S. Application Data
(60) Provisional application No. 63/448,847, filed on Feb. 28, 2023.
(60) Provisional application No. 63/453,001, filed on Mar. 17, 2023.

(51) Int. Cl. G06K 7/10; B66F 9/075; G06K 7/14; H04N 7/18; H04N 23/56; H04N 23/60; H04N 23/698; H04N 23/74; H04N 23/90

(52) U.S. Cl. CPC G06K 7/10732; B66F 9/0755; G06K 7/1413; H04N 7/181; H04N 23/56; H04N 23/64; H04N 23/698; H04N 23/74; H04N 23/90

(57) ABSTRACT

Mechanisms are described for scanning items while they remain loaded on a forklift (or other mobile carrier), or while the items are being loaded or unloaded in the normal course of warehouse operations. An apparatus including any number of scanner(s) (such as image capture device(s) or other devices for capturing information about physical items) may be affixed to the mobile carrier, and may be configured to automatically actuate during loading and unloading operations. The scanner(s) may be configured to automatically commence information capture when loading/unloading operations commence, and to automatically stop capture when loading/unloading operations are completed. Automatically actuated lamp(s) may also be provided to aid in information capture. The apparatus may be configured to automatically transmit captured information, such as image(s) and/or video of loading/unloading operation(s), including cargo item(s), to a cloud-based computing device for analysis and/or storage, for example to identify cargo item(s) and/or their destinations.

### CROSS-REFERENCE TO RELATED APPLICATIONS

The present application claims the benefit of U.S. Provisional Application Ser. No. 63/448,847 for “Forklift-Based Scanner”, (Attorney Docket No. KAR002-PROV), filed on Feb. 28, 2023, which is incorporated by reference herein in its entirety.

The present application claims the benefit of U.S. Provisional Application Ser. No. 63/453,001 for “Multi-Camera Image Capture System”, (Attorney Docket No. KAR003-PROV), filed on Mar. 17, 2023, which is incorporated by reference herein in its entirety.

The present application is related to U.S. Utility application Ser. No. 17/488,031 for “Freight Management Systems and Methods”, filed on Sep. 28, 2021, which is incorporated by reference herein in its entirety.

The present application is related to U.S. Utility application Ser. No. 17/488,033 for “Freight Management Systems and Methods”, filed on Sep. 28, 2021, which is incorporated by reference herein in its entirety.

### TECHNICAL FIELD

The present document relates to an apparatus and method for capturing information about cargo items loaded on a forklift.

### BACKGROUND

Conventionally, in order to obtain information about cargo and other items that are being carried by a mobile carrier such as a forklift, it is often necessary to remove the items from the forklift (and subsequently reload them onto the forklift) specifically in order to scan them using an image capture device or other scanning device. Such removal and reloading, especially when performed repeatedly, can consume considerable time and labor, and can increase the potential for damage and/or wear to the item(s) and/or forklift, accidents, injury to personnel, and/or the like.

### SUMMARY

Various embodiments described herein provide mechanisms for scanning items while they remain loaded on a forklift (or other mobile carrier), or while the items are being loaded or unloaded in the normal course of warehouse operations. As described herein, such an apparatus and/or method can improve efficiency and safety.

In at least one embodiment, an apparatus including any number of scanner(s) may be affixed to a forklift or other mobile carrier, and may be configured to automatically capture information about cargo items during loading and unloading operations. For example, such scanner(s) may be image capture device(s), which capture images or video depicting cargo items. Such image capture or video capture may automatically commence and stop based on detection of nearby cargo items, and/or based on detection of commencement and completion of loading and/or unloading operations. One or more distance-measuring sensor(s) may be employed to detect nearby cargo items and/or loading/unloading areas, so as to determine appropriate time(s) to start and stop scanning operations.

In various embodiments, the apparatus may include a main unit and/or any number of additional auxiliary module(s) including lamp(s) and/or additional scanner(s). As described in more detail herein, such lamp(s) may be configured to be automatically activated when loading/unloading operations commence, and to be automatically deactivated when loading/unloading operations are completed. The scanner(s) may similarly be configured to automatically commence scanning (capture) when loading/unloading operations commence, and to automatically stop scanning (capture) when loading/unloading operations are completed.

In various embodiments, the apparatus may be configured to automatically transmit captured information, such as image(s) and/or video of loading/unloading operation(s), including cargo item(s), to a cloud-based computing device for analysis and/or storage, for example to identify cargo item(s) and/or their destinations. Such analysis may include, for example, reading text, barcode(s), and/or other information on cargo item(s) and/or label(s) affixed to same.

In various embodiments, the apparatus and method described herein are not limited to use with forklifts, but may be used in connection with any mobile carrier of items such as cargo, and in any context or environment. The apparatus and method described herein are not limited to capture of optical or visual information, but may be used for any type of scanning, whether optical/visual, RFID, magnetic, and/or the like, and can be applied to labels, exterior markings, and/or other information printed on, affixed to, or included within the items.

Further details and variations are described herein.

### BRIEF DESCRIPTION OF THE DRAWINGS

The accompanying drawings, together with the description, illustrate several embodiments. One skilled in the art will recognize that the particular embodiments illustrated in the drawings are merely exemplary, and are not intended to limit scope.

FIG. 1 is a block diagram depicting a hardware architecture for implementing a forklift-based cargo scanning apparatus according to one embodiment.

FIG. 2A is a flow diagram depicting a method for capturing cargo item data during a loading operation via a forklift-based apparatus including scanners, according to one embodiment.

FIG. 2B is a flow diagram depicting a method for capturing cargo item data during an unloading operation via a forklift-based apparatus including scanners, according to one embodiment.

FIG. 3 is a simplified side view depicting an example of operation of a forklift-based apparatus to detect cargo item(s) at fork distance, as well as more distant cargo item(s), according to one embodiment.

FIG. 4 depicts an arrangement for a cargo scanning apparatus in which various components may be affixed to a backrest of a forklift, according to one embodiment.

FIG. 5 depicts two views of an example of a main unit of a cargo scanning apparatus, according to one embodiment.

FIG. 6 depicts an exploded view of a main unit of a cargo scanning apparatus, according to one embodiment.

FIGS. 7 and 8 depict two views of an example embodiment of a forklift-based cargo scanning apparatus.

FIG. 9 depicts inputs and outputs for a power distribution board for a forklift-based cargo scanning apparatus, according to one embodiment.

FIG. 10 is a block diagram depicting inputs and outputs for a main board for implementing a forklift-based cargo scanning apparatus, according to one embodiment.

FIGS. 11A, 11B, and 11C depict various views of a center-mounted scanner arrangement for implementing a forklift-based cargo scanning apparatus, according to one embodiment.

FIG. 12 depicts a view of a center-mounted scanner arrangement with distributed scanners, for implementing a forklift-based cargo scanning apparatus, according to one embodiment.

FIG. 13 depicts a view of a column-mounted scanner arrangement for implementing a forklift-based cargo scanning apparatus, according to one embodiment.

FIG. 14 depicts an example of various types of visually readable elements that may be captured and/or read using a forklift-based cargo scanning apparatus and/or method.

FIG. 15 depicts an example of a main unit of a cargo scanning apparatus, according to one embodiment.

FIG. 16 is a block diagram depicting various components of a cargo scanning apparatus, according to one embodiment.

### DETAILED DESCRIPTION OF THE EMBODIMENTS

### Definitions and Concepts

For purposes of the description provided herein, the following definitions may apply:
A “scanner” refers to an image capture device, video capture device, and/or any other device capable of capturing visual or nonvisual information about a cargo item, package, object, and/or other item. Scanners thus include magnetic, optical, and/or RFID scanners, as well as any other type of device capable of capturing such information.
An “image capture device” or “video capture device” (also referred to as a “camera”) is any device capable of capturing a visual or optical image (whether still image or video) of a cargo item, package, object, and/or other item.
“Scanning” or “capturing” refers to the process of capturing visual or nonvisual information about a cargo item, package, object, and/or other item.
A “forklift” refers herein to any mobile device or vehicle capable of carrying cargo or any other package, object, and/or other item. One skilled in the art will recognize that the techniques, apparatuses, and methods described herein may be implemented in connection with other types of apparatus that can carry cargo and/or other items, and are not limited to forklifts. Accordingly, while the term “forklift” is used, such usage should be interpreted as including any cargo carrying device which may or may not be mobile, and which may take any form.
“Cargo”, “cargo item”, or “item” refer interchangeably to any package, object, and/or other item that may be shipped, loaded, stored, or otherwise handled.
“Lamp” refers to any device for illuminating a scene or object.
“Volume of interest” refers to an area that may be scanned by a scanner, in order to capture visual or nonvisual information about objects and/or items within such area. For example, for a forklift, the volume of interest may include the area where cargo items are generally carried by the forklift.
“Critical recording period” refers to a period during which it is desirable or advantageous to capture information about an item. For example, a critical recording period may include a loading session and/or an unloading session.
“Loading session” refers to a period which item(s) is/are being loaded onto a forklift.
“Unloading session” refers to a period which item(s) is/are being unloaded off a forklift.

### Overall Architecture

In at least one embodiment, the techniques described herein can be implemented in connection with Warehouse Management Systems (WMS) wherein cargo and/or other items may be scanned, tracked, and/or inventoried while being loaded, unloaded, and/or stored in a warehouse. In such contexts, it can be useful to provide systems, apparatuses, and/or devices for automated optical reading of barcodes, text, labels, and/or other visually readable elements that may appear on (or within) boxes, labels, packaging, and/or the items themselves.

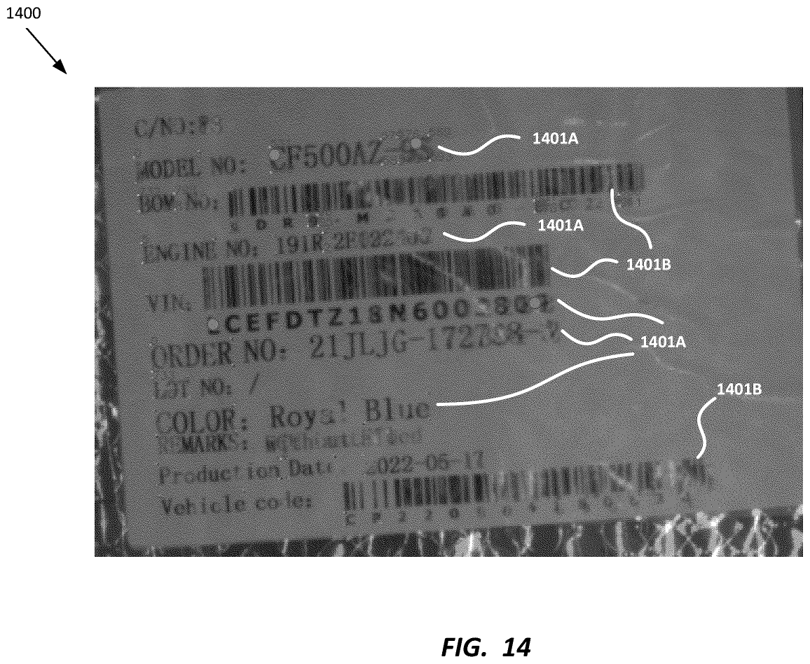

Referring now to FIG. 14, there is shown an example 1400 of various types of visually readable elements 1401, such as text elements 1401A and barcode elements 1401B, that may be captured and/or read using the apparatus and/or method described herein. Image capture of visually readable elements such as 1401A and 1401B is merely one example of such scanning; in other embodiments, magnetic, RFID, and/or other types of scanning can be performed.

Such elements 1401 may be scanned when items enter or leave a warehouse, when inventory is counted or checked, when items are being moved from one location to another within the warehouse, and/or at any other suitable time. Information from such scans may be interpreted by a local processor and/or may be transmitted to cloud-based computing equipment, in order to identify the items that were scanned. In this manner, location tracking, inventory management, loss management, sales, and/or other information may be automatically updated, and such information may be used as the basis for various reports in connection with a WMS or other system.

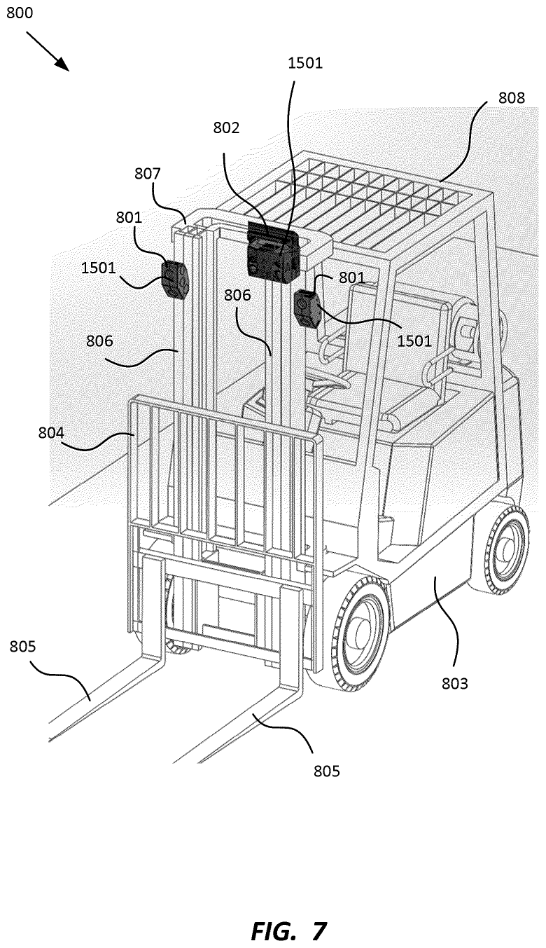

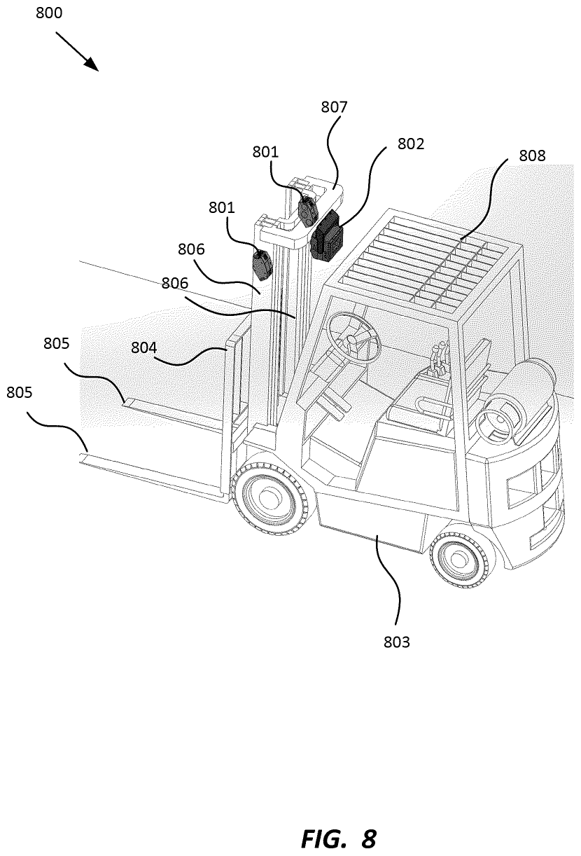

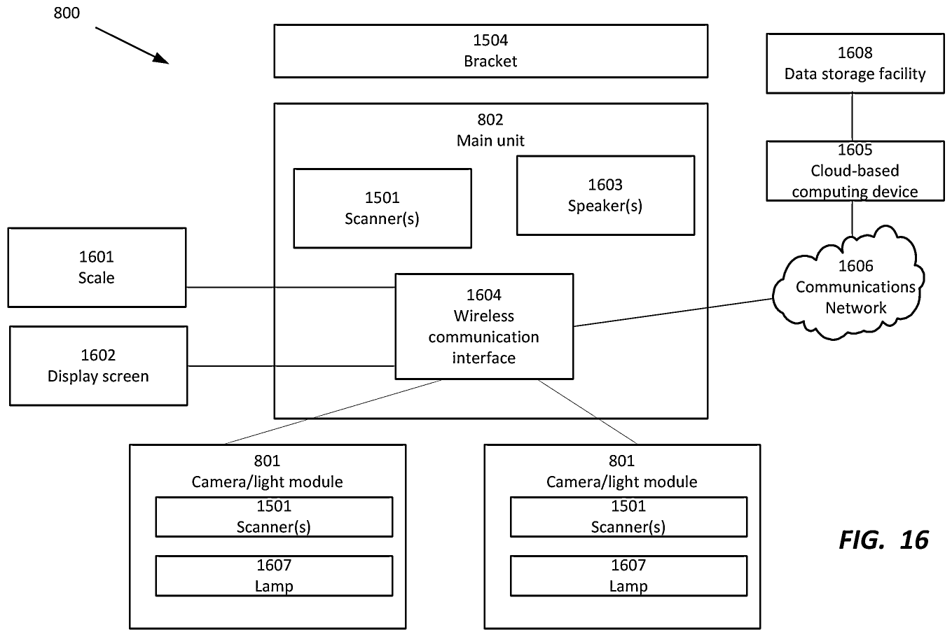

Referring now to FIGS. 7 and 8, there are shown two views of an example embodiment of a forklift-based cargo scanning apparatus 800, according to one embodiment. Referring also to FIG. 16, there is shown a block diagram depicting various components of apparatus 800, according to one embodiment.

In at least one embodiment, apparatus 800 may include main unit 802, which may be mounted to (or integrated into) a mobile carrier such as forklift 803, and which may include one or more scanner(s) 1501 along with other hardware for implementing the techniques described herein. In at least one embodiment, apparatus 800 may also include one or more auxiliary module(s) 801, which may also be mounted to (or integrated into) forklift 803. As described below, in some arrangements, module(s) 801 may include illumination device(s) (lamp(s)), whereas in other arrangements they may include scanner(s) 1501, and in yet other arrangements they may include both lamps and scanner(s) 1501. Such module(s) 801 may communicate with (and be controlled by) main unit 802 via any suitable wired or wireless communication means. In at least one embodiment, lamp(s) may be selectively activated, either automatically or manually, when images of items are to be captured, as described in more detail below.

In at least one embodiment, as depicted in FIGS. 7 and 8, main unit 802 and/or auxiliary module(s) 801 may be affixed to columns 806 and/or crossbar 807 of forklift 803, and may be situated and oriented so that scanner(s) 1501 located therein can capture images of item(s) loaded on forklift 803. In at least one embodiment, main unit 802 and/or auxiliary module(s) 801 may be situated and oriented so that scanner(s) 1501 located therein are not occluded by backrest 804 even when backrest 804 is at its highest position.

In at least one embodiment, apparatus 800 may be configured to automatically read labels, dimensions, weights, and/or any other information associated with cargo and/or other items that may be loaded onto forklift 803, or that may be in the process of being loaded onto or unloaded off forklift 803. Advantageously, such reading of information may take place automatically and/or without interfering with normal loading/unloading operations. Further details are provided below.

In at least one embodiment, apparatus 800 may include or communicate with any or all of the following, in any suitable combination:
one or more scanner(s) 1501 such as camera(s) or the like, integrated in main unit 802 or auxiliary module(s) 801, for capturing images of items, labels, boxes, text, machine-readable codes, and/or the like;
one or more auxiliary modules 801, which may be external to main unit 802, and which may include additional scanner(s) 1501 and/or lamp(s) 1607 to illuminate items to be scanned;
a scale 1601 or other weight sensing mechanism;
a visual output device such as display screen 1602 and/or status indicator lights, which may provide visual output, for example to confirm when a scan has been successfully performed, and/or to indicate that the scan was not successful, and/or to provide feedback for the forklift operator.
an audio output device such as one or more speakers 1603, which may be part of main unit 802 or may be external to main unit 802, for example mounted in cab 808, and which may provide beeps, alerts, and/or spoken output, for example to confirm when a scan has been successfully performed, and/or to indicate that the scan was not successful, and/or to provide feedback for the forklift operator.
a wireless communication interface 1604, enabling communication via Wifi, Bluetooth, and/or any other suitable communication means, among various components such as main unit 802, scale 1601, and/or display screen 1602, as well as to communicate with cloud-based computing device 1605 (via communications network 1606), for example to provide images, video streams, and/or information about scanned items to device 1605, which may process such information and/or store it at data storage facility 1608; and/or
a bracket 1504 or other mechanism to affix or connect main unit 802 to forklift 803.

In at least one embodiment, some or all of the above-listed components can be integrated into main unit 802; alternatively, some or all of the components may be provided separately from main unit 802. For example, scale 1601 may be affixed to forks of forklift 803, rather than being incorporated into main unit 802. As another example, auxiliary module(s) 801 may be affixed to forklift 803 in a manner that allows scanner(s) 1501 in auxiliary module(s) 801 to capture images of cargo and other items from a different angle than scanner(s) 1501 in main unit 802, thus providing more reliable scans of cargo and other items. Auxiliary module(s) 801 may also be positioned and oriented so that lamp(s) 1607 can most effectively illuminate cargo and other items for scanning.

In at least one embodiment, display screen 1602 may be provided as a separate component in the cab of forklift 803, or in a separate area entirely, and may communicate with main unit 802 by wireless or wired communication means. In at least one embodiment, some components, such as scale 601 and/or display screen 1602, may communicate with main unit 802 and/or other components via wireless communication interface 1604 or by other suitable means.

In at least one embodiment, data transmission among the various components of apparatus 800 may take place via any suitable wired or wireless communication mechanism. Data collected by main unit 802, including for example image data captured by scanner(s) 1501, may be transmitted via communications network 1606 to cloud-based computing device 1605 that may run WMS software and/or other software for tracking items in a warehouse.

In at least one embodiment, scanner(s) 1501 may be configured to capture video streams, which can then be analyzed to read bar codes, text, and/or other information on cargo items. In another embodiment, scanner(s) 1501 may be configured to capture still images.

In at least one embodiment, software running at cloud-based computing device 1605 may store video data (such as video stream(s) captured by scanner(s) 1501) on cloud-based data storage facility 1608. Software running at cloud-based computing device 1605 may truncate the captured video data into small video clips that may represent loading and/or unloading events, images of barcodes, and/or other relevant data, as may be specified by a user.

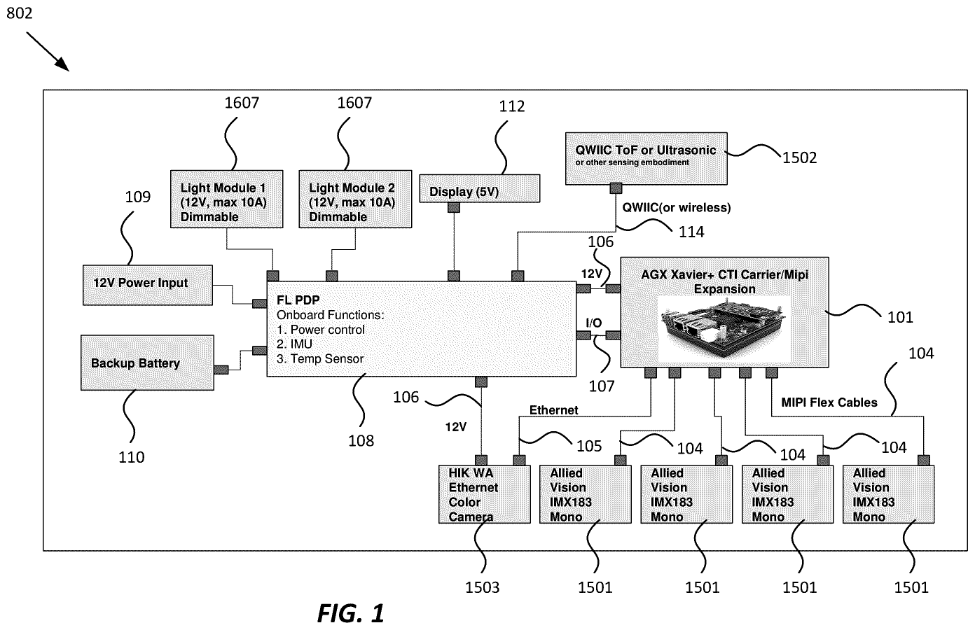

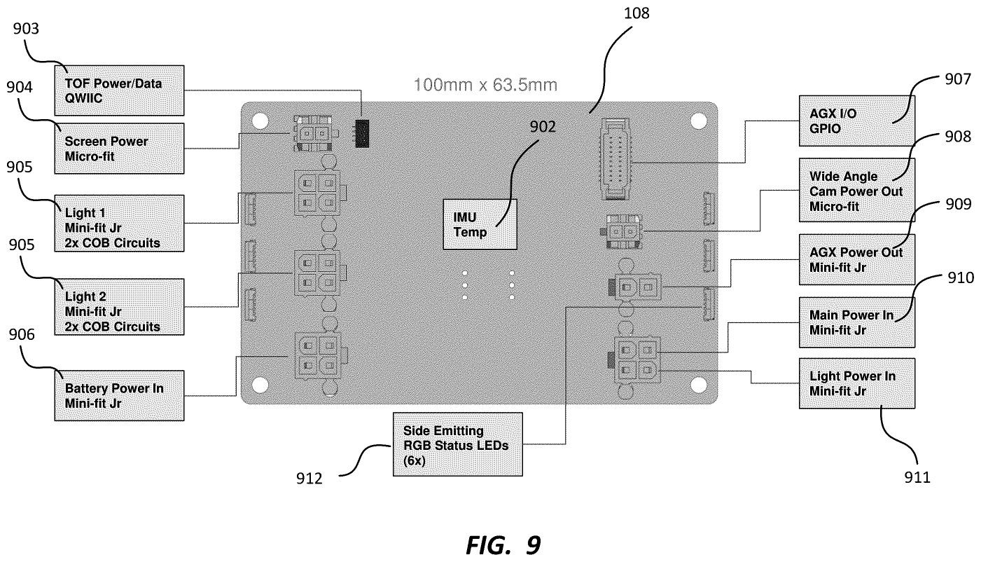

In at least one embodiment, any or all components of apparatus 800 may be battery-powered. In various embodiments, apparatus 800 may be powered directly from a battery of forklift 803. In alternative embodiments, other power sources may be used. For example, in at least one embodiment, a removable portion of main unit 802 and/or each auxiliary module 801 may be provided with a battery pack which may be included in main unit 802 or may be external, and which may include some number of battery cells, such as three battery cells. A charging board, such as for example a lithium ion 3S1P 18650 cell pack with an internal battery management system (BMS) may be provided to connect the cells to one another and to allow the battery assembly to mate with a charging system; the charging board may be integrated into PCBA power distribution (PD) board 108 as depicted herein in connection with FIGS. 1 and 9. In at least one embodiment, the battery pack can be dropped into a housing which may be internal to main unit 802 or may be a separate component, for powering scanner(s) 1501, and may be fastened by any suitable mechanism. In at least one embodiment, the battery pack may be a removable component using an interface similar to that used for e-bikes or power tools. In addition, in at least one embodiment, battery backup functionality may be provided, so that main unit 802 may detect power loss and log it to memory; battery backup functionality may allow main unit 802 to continue to function in a low power state until full power is restored.

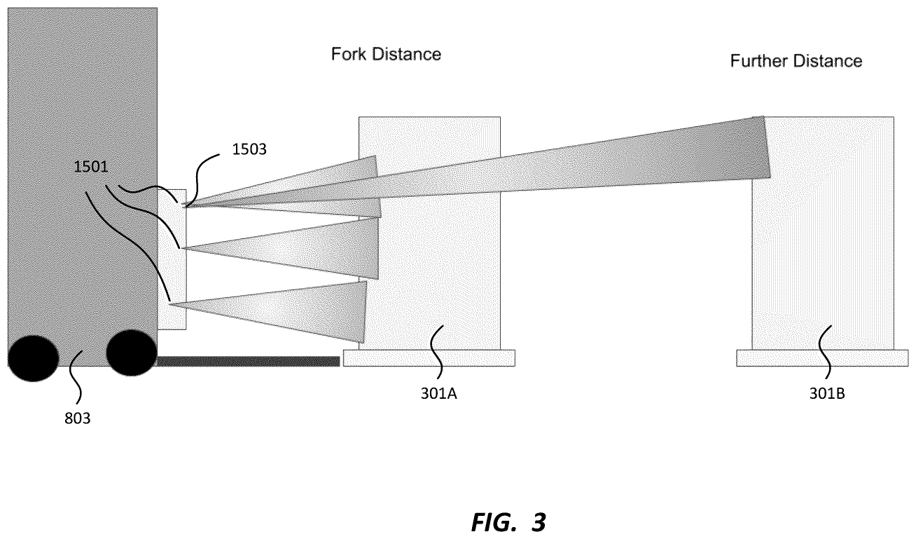

Referring now to FIG. 3, there is shown a simplified side view depicting an example of operation of apparatus 800 to detect cargo item(s) 301A at fork distance, as well as more distant cargo item(s) 301B. Wide-angle image capture device(s) 1503 and/or sensor(s) 1502 (which may be any type of sensor for detecting proximity of objects, such as for example a Time-of-Flight (ToF) sensor, an ultrasonic sensor, a mmWave radar sensor, a lidar sensor, or the like; not shown in FIG. 3) may detect more distant cargo item(s) 301B, while scanner(s) 1501 may capture images of cargo item(s) 301A once item(s) 301A are within fork distance.

### Center-Mounted Scanner Arrangement

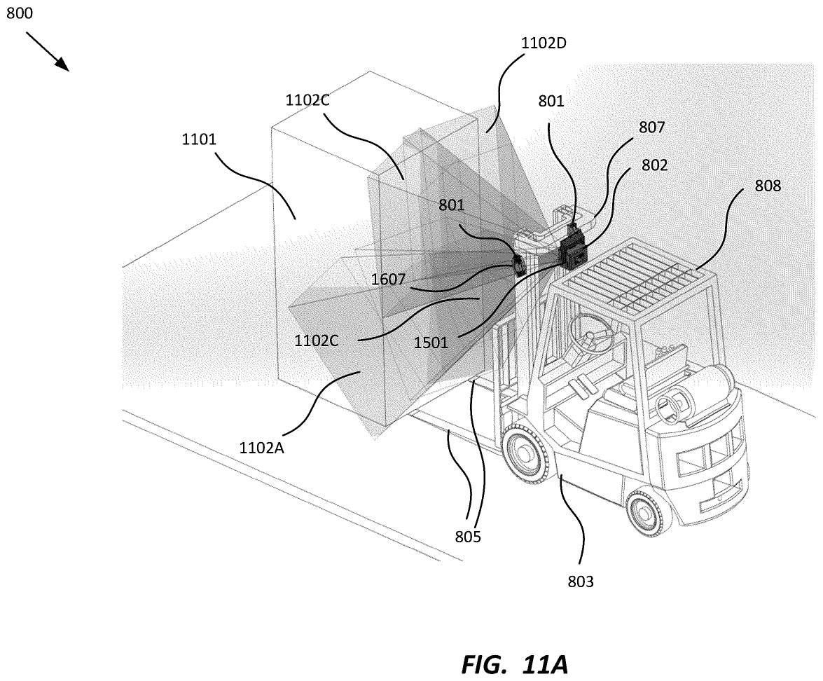

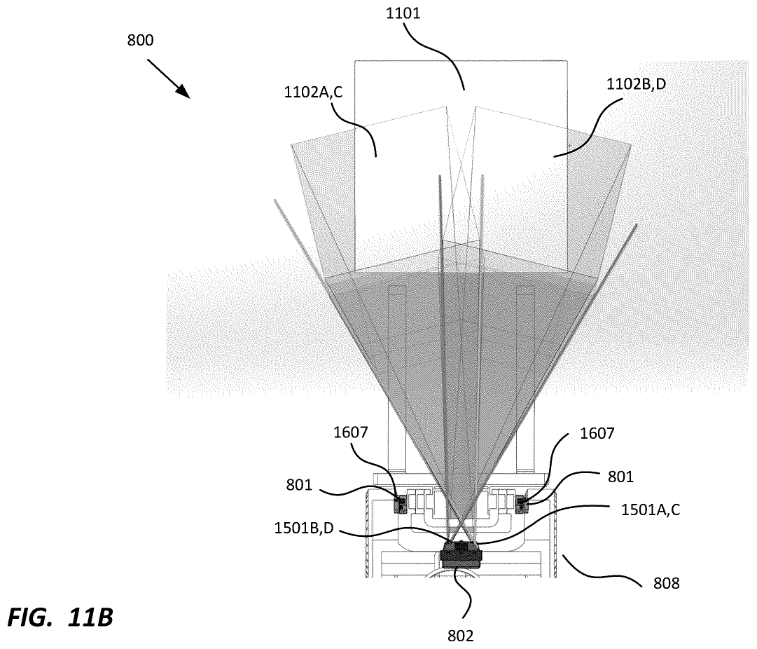

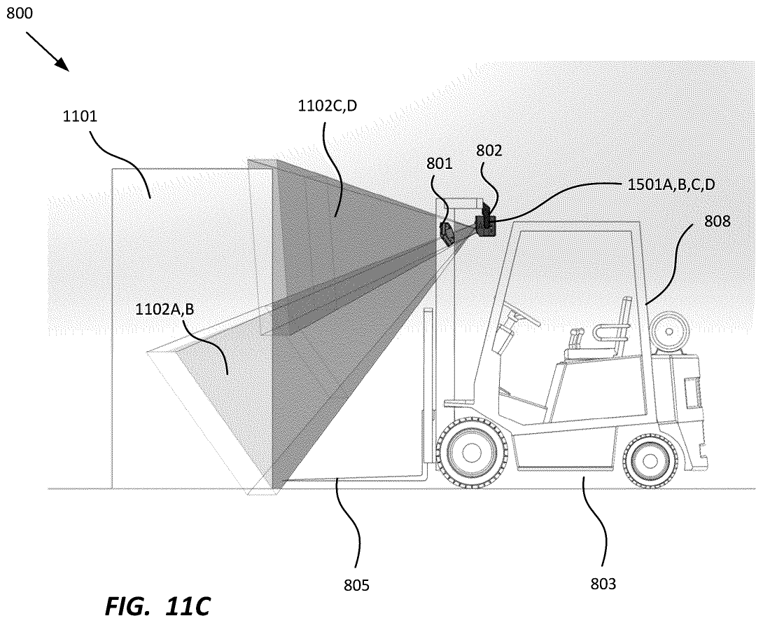

Referring now to FIGS. 11A, 11B, and 11C, there are shown various views of a center-mounted scanner arrangement for implementing forklift-based cargo scanning apparatus 800, according to one embodiment. As in FIGS. 7 and 8, main unit 802 may be affixed to crossbar 807, and auxiliary module(s) 801 may be affixed to columns 806, in a center-mounted scanner arrangement. In the arrangement shown in FIGS. 11A, 11B, and 11C, modules 801 contain illumination devices (lamps 1607), but no scanners 1501; all scanners 1501 are located in center-mounted main unit 802. Main unit 802 and modules 801 may be fixed or may be movable, either manually or automatically, for example to better illuminate items to be scanned, or to better orient scanner(s) 1501 to capture images of items.

The arrangement shown in FIGS. 11A, 11B, and 11C allows a large area of target pallet area 1101 to be viewed by scanner(s) 1501. For example, four scanner(s) 1501 may be provided, for capturing four quadrants of target pallet area 1101 (upper left, upper right, lower left, and lower right), as follows:
Scanner(s) 1501A, 1501C can capture cargo items within lower left area 1102A and upper left area 1102C, respectively; and
Scanner(s) 1501B, 1501D can capture cargo items within lower right area 1102B and upper right area 1102D, respectively.

In this manner, the center-mounted scanner arrangement depicted in FIGS. 11A, 11B, and 11C can effectively capture images of cargo items in all (or nearly all) areas of target pallet area 1101 during loading and/or unloading operations.

Other advantages and features of the center-mounted scanner arrangement may include the following:
The mounting location is well protected;
Power routing from forklift battery is simplified;
Scanner(s) 1501 may be spread wider on in the enclosure and aligned in a crossing pattern;
Allows for wider field of view to “look around” columns 806.
   Center-Mounted Scanner Arrangement with Distributed Scanners

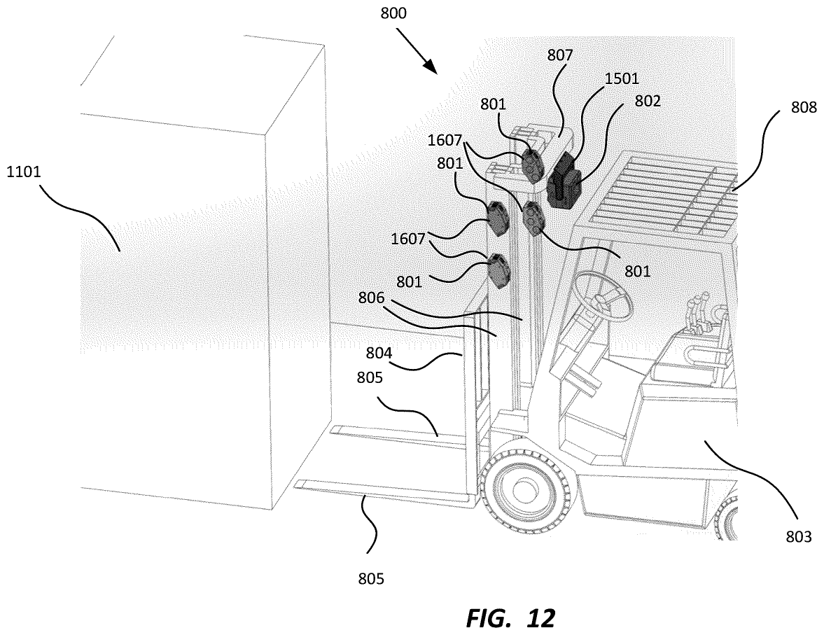

Referring now to FIG. 12, there is shown a view of a center-mounted scanner arrangement with distributed scanners, according to one embodiment. As in FIGS. 7 and 8, main unit 802 may be affixed to crossbar 807, and auxiliary module(s) 801 may be affixed to columns 806, in a center-mounted scanner arrangement. In the arrangement shown in FIG. 12, modules 801 contain scanners 1501 as well as illumination devices (lamps 1607); the scanners 1501 may be provided in addition to scanner 1501 in main unit 802. In an alternative embodiment, main unit 802 may include no scanners 1501, so that image capture is performed only via scanner(s) 1501 in auxiliary module(s) 801. In yet another alternative embodiment, some auxiliary module(s) 801 may contain scanners 1501 while others contain lamps 1607. Thus, scanners 1501 and lamps 1607 can be housed in the same enclosures or in discrete enclosures.

Main unit 802 and auxiliary module(s) 801 may be fixed or may be movable, either manually or automatically, for example to better illuminate items to be scanned, or to better orient scanner(s) 1501 to capture images of items. In an alternative embodiment, main unit 802 may be located in any suitable location, such as inside cab 808, particularly if main unit 802 does not contain any scanners 1501.

The arrangement shown in FIG. 12 allows a large area of target pallet area 1101 to be viewed by scanner(s) 1501, since auxiliary module(s) 801 including scanner(s) 1501 may be distributed at various locations on columns 806 of forklift 803. Image data may be transmitted from scanner(s) 1501 in auxiliary module(s) 801 to main unit 802 via any wired or wireless communication means, such as for example USB, Gigabit Multimedia Serial Link (GSML), Ethernet, WiFi, Bluetooth, or the like.

Other advantages and features of the center-mounted scanner arrangement may include the following:
The mounting location is well protected;
Power routing from forklift battery is simplified;
Scanner(s) 1501 positioned within auxiliary module(s) 801 mounted on columns 806 of forklift 803 may have clear line of sight to target pallet area 1101.

### Column-Mounted Arrangement

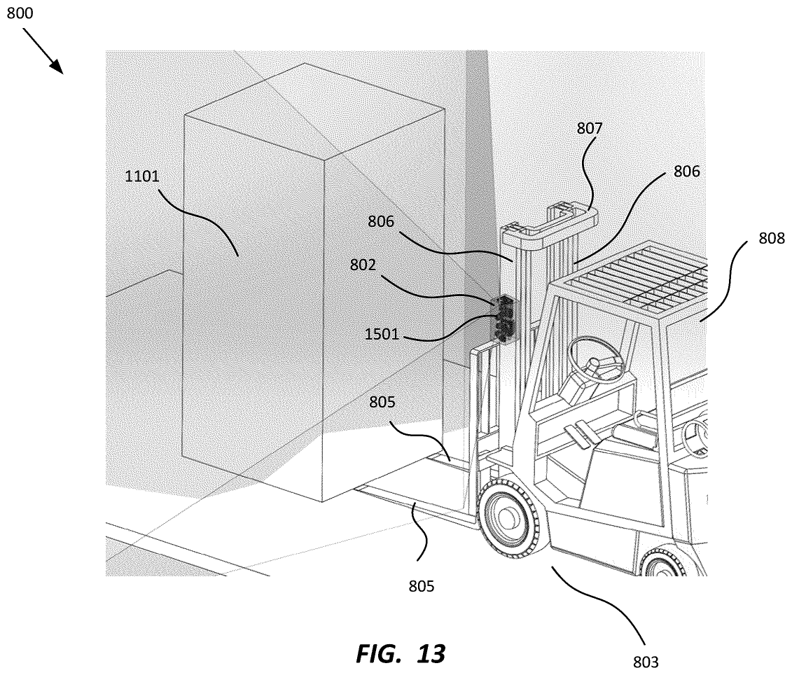

Referring now to FIG. 13, there is shown a view of a column-mounted scanner arrangement, according to one embodiment. Main unit 802 may be affixed to one or both columns 806 of forklift 803. In the example arrangement shown in FIG. 13, no auxiliary modules 801 are included, so that all scanners 1501 (and, optionally, illumination device(s) (lamp(s) 1607)) are included in main unit 802.

Such an arrangement may provide for easier installation since all components are consolidated into a single enclosure. In addition, installation can be modular, with either one unit or more than one (e.g., one on each column 806).

Main unit 802 may be fixed or may be movable, either manually or automatically, for example to better illuminate items to be scanned, or to better orient scanner(s) 1501 to capture images of items.

Other advantages and features of the center-mounted scanner arrangement may include the following:
The mounting location is somewhat protected;
Power routing from forklift battery is simplified;
Scanner(s) 1501 positioned within main unit 802 mounted on one or both columns 806 of forklift 803 may have clear line of sight to target pallet area 1101.

### Backrest-Mounted Arrangement

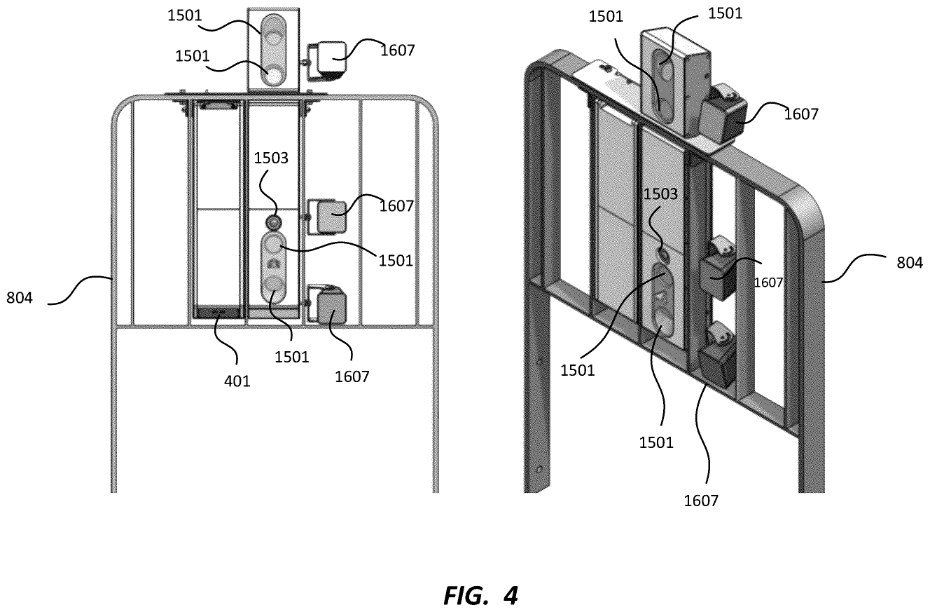

Referring now to FIG. 4, there is shown an alternative embodiment wherein various components may be affixed to a backrest 804 of forklift 803, according to one embodiment. Such components include, for example, scanner(s) 1501, wide-angle image capture device(s) 1503 (e.g., wide angle camera(s)), lamp(s) 1607, and/or charging port 401, all of which are described in more detail below. One advantage of such an approach is that scanner(s) 1501 and lamp(s) 1607 move in tandem with movement of forks 805 of forklift 803, since backrest 804 is fixedly attached to forks 805. By moving scanner(s) 1501 and lamp(s) 1607 in tandem with forks 805, scanner(s) 1501 and lamp(s) 1607 are more likely to be properly aimed at the item(s) to be scanned, resulting in a higher-quality, more stable image of the item(s) loaded on forklift 803 even when forks 805 are raised or lowered. For this reason, it may be advantageous, in some embodiments, to affix various components of apparatus 800 to backrest 804, so that (a) they move vertically in tandem with forks 805; and (b) they are not occluded by columns 806 or other components of the forklift 803.

One skilled in the art will recognize that other arrangements and locations for scanner(s) 1501 may be used. In another embodiment, some or all scanner(s) 1501 may be affixed to cab 808.

### Main Unit 802 and Auxiliary Module(s) 801

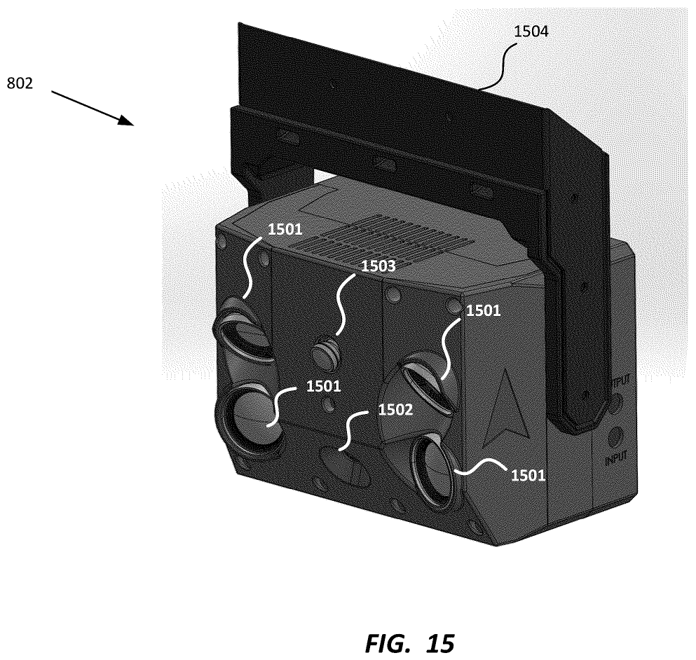

Referring now to FIG. 15, there is shown an example of main unit 802, including four scanners 1501 which may be oriented in different directions, along with wide-angle image capture device 1503 and distance-measuring sensor(s) 1502, which may be any type of sensor for detecting proximity of objects, such as for example a Qwiic Time-of-Flight (ToF) sensor, an ultrasonic sensor, a mmWave radar sensor, a lidar sensor, or the like. Bracket 1504 may be used to affix main unit 802 to forklift 803.

Referring now to FIG. 1, there is shown an example of a hardware architecture for main unit 802, according to one embodiment. In at least one embodiment, main unit 802 may include any or all of the following components. Specific examples of models of components are provided as examples only.
Main board 101, such as for example an NVidia Jetson Orin AGX board, with SmartFusion2 MIPI CSI-2 daughter board (video card);
Any number of scanner(s) 1501, such as for example four HD Allied Vision IMX183 cameras, coupled to main board 101 via MIPI flex cables 104;
Wide-angle HIKROBOT camera 1503, coupled to main board 101 via Ethernet cable 105;
FL PCBA power distribution (PD) board 108, coupled to main board 101 via 12V power cable 106 and/or I/O cable 107 (board 108 may include components for power control, Inertial Measurement Unit (IMU), and/or temperature sensor);
Qwiic Time-of-Flight (ToF) or ultrasonic sensor 1502, such as SparkFun Qwiic Mini ToF Imager VL53L5CX, available from SparkFun Electronics of Niwot, Colorado, which may communicate with other components via Qwiic or wireless connection 114;
Any number of lamp(s) 1607, such as for example two 12-volt dimmable light modules, coupled to PD board 108;
Display 112 coupled to PD board 108;
Digi IX10 gateway (Network communication link) (not shown);
12V power input 109 coupled to PD board 108; and
Backup battery 110 coupled to PD board 108.

In at least one embodiment, main board 101 may control wide-angle image capture device 1503, scanner(s) 1501, distance-measuring sensor(s) 1502, lamp(s) 1607, and/or the network communication link. An externally mounted power switch (not shown) may control electrical connection(s) between PD board 108 and power input 109 and/or backup battery 110.

As described above, scanners 1501 may include one or more high-definition (HD) cameras and/or any other devices that may be well-suited to reading labels containing text and/or barcodes.

In at least one embodiment, one or more wide-angle image capture device(s) 1503 (such as wide-angle camera(s)) may be used, either instead of or in addition to scanner(s) 1501. Each wide-angle image capture device 103 may be included in main unit 802, or installed separately on forklift 803, for example adjacent to main unit 802 and/or adjacent to auxiliary module(s) 801, or in any other suitable location. Wide-angle image capture device(s) 103 may be configured to capture additional images of item(s) being carried by forklift 803. Wide-angle image capture device(s) 103 may help detect damage to the item(s), as well as to provide an overall context for image(s) captured by scanner(s) 1501.

In at least one embodiment, scanner(s) 1501 may include image capture device(s), video capture device(s), and/or other device(s) that may capture visual or nonvisual information about cargo items. For example, scanner(s) 1501 may capture magnetic or RFID information from cargo items or from labels affixed to such items. For simplicity of the description herein, all references to scanner(s) 1501 should be considered to include image capture device(s), video capture device(s), and/or other types of scanner(s), including those that may capture nonvisual information.

In at least one embodiment, main unit 802 of apparatus 800 may be configured to communicate with a cloud-based computing device 1605 running a WMS, using communications network 1606, which may be any suitable wireless or wired communication means such as the internet. In this manner, information obtained by forklift-based cargo scanning apparatus 800 may be used to track cargo items and/or other items, perform inventory operations, route items to their destinations, and/or perform any other tasks associated with WMS and/or cargo tracking.

In at least one embodiment, main unit 802 of apparatus 800 may be configured to provide feedback for forklift operators so as to improve scans and/or improve efficiency in obtaining scans. Such feedback may be provided in any suitable form, such as for example auditory and/or visual feedback, via any suitable output device such as speaker(s), screen(s), and/or indicator light(s). Feedback may also include safety warnings and the like.

For purposes of the description here, various components are described as being affixed to forklift 803. However, one skilled in the art will recognize that the techniques, apparatuses, and methods described herein may be affixed to or associated with other types of apparatus that can carry cargo and/or other items, and are not limited to forklift 803. Accordingly, while the term “forklift” is used, such usage should be interpreted as meaning any cargo carrying device which may or may not be mobile, and may take any form.

In at least one embodiment, as depicted in FIGS. 7 and 8, one or more auxiliary module(s) 801 may also be mounted to (or integrated into) forklift 803; such module(s) 801 may include additional scanners 1501 and may communicate with main unit 802 via any suitable wired or wireless communication means. In at least one embodiment, main unit 802 and/or auxiliary module(s) 801 may also provide lighting that may be selectively activated, either automatically or manually, when images of items are to be captured, as described in more detail herein.

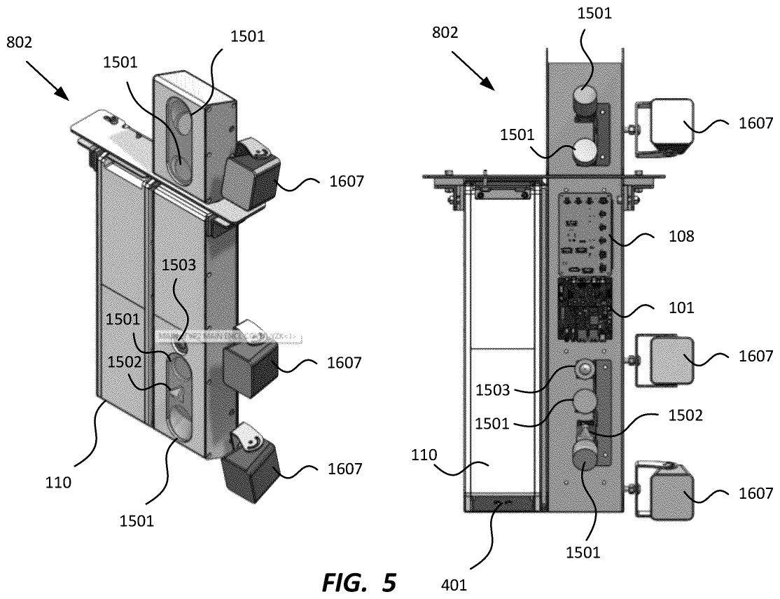

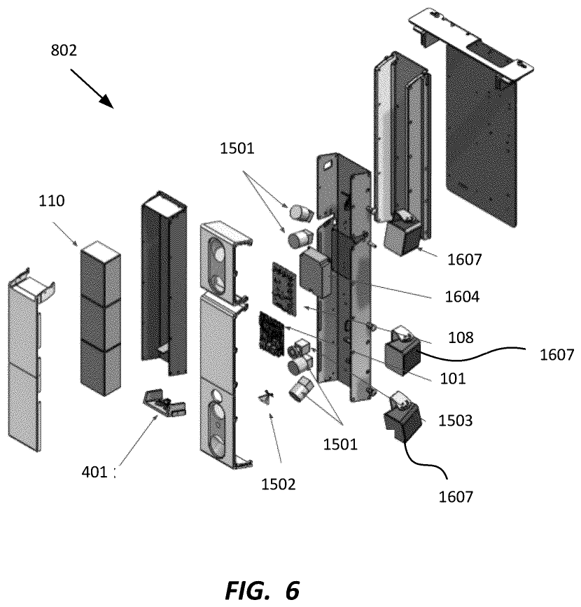

Referring now to FIG. 5, there are shown two views of an example of an alternative embodiment for main unit 802, according to one embodiment. Referring now also to FIG. 6, there is shown an exploded view of the example alternative embodiment of FIG. 5. Depicted in FIGS. 5 and/or 6 are the following components:
Scanners 1501 (which may be image capture devices or other types of information capture devices);
Wide-angle image capture device 1503;
Distance-measuring sensor(s) 1502;
Lamps 1607;
Main board 101;
FL PCBA power distribution (PD) board 108;
Backup battery 110;
Charging port 401, which may be used to charge backup battery 110.

### Board Layout

Referring now to FIG. 9, there is shown a diagram depicting inputs and outputs for FL PCBA power distribution (PD) board 108, according to one embodiment. In at least one embodiment, board 108 may include module 902 consisting of an Inertial Measurement Unit (IMU) such as an IAM-20680 motion tracking device available from TDK Corporation of San Jose, California, and/or a temperature sensor; in other embodiments, such components may be provided separately. In at least one embodiment, the following inputs and outputs may be provided.
Interface 903 to distance-measuring sensor(s) 1502, which may be any type of sensor adapted to detect proximity of items, such as for example a Qwiic Time-of-Flight (ToF) sensor, an ultrasonic sensor, a mmWave radar sensor, a lidar sensor, or the like.
Power 904 for display screen;
Control outputs 905 for lamp(s) 1607;
Input 906 for battery power;
Interface 907 to main board 101;
Power and/or interface 908 for wide-angle image capture device 1503;
Power 909 for main board 101;
Main power in 910;
Light power in 911;
Status LEDs 912.

In other embodiments, additional auxiliary outputs (such as 12V, 5V, 3.3V, and/or 18V outputs) may be provided for additional items. For example, an additional 12V output may be provided to power scanner(s) 1501 so as to take power load off main board 101.

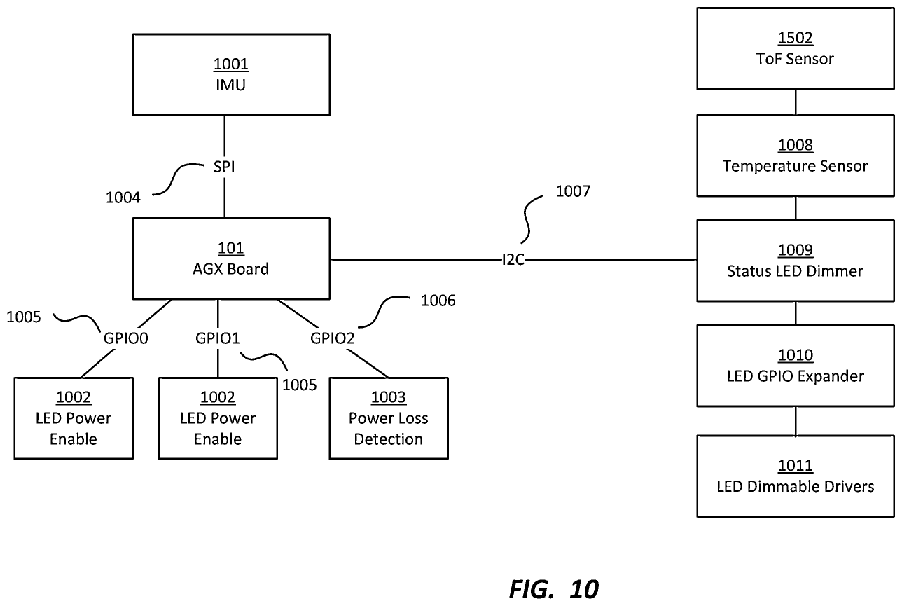

Referring now to FIG. 10, there is shown a diagram depicting inputs and outputs for main board 101, according to one embodiment. In at least one embodiment, the following inputs and outputs may be provided:
Serial Peripheral Interface (SPI) 1004 for Inertial Measurement Unit (IMU) 1001 (e.g., IAM-20680 motion tracking device available from TDK Corporation of San Jose, California), which in one embodiment is integrated into board 108;
General Purpose Input/Output (GPIO) connections 1005 for enabling power to lamp(s) 1607 via control outputs 905;
General Purpose Input/Output (GPIO) connection 1006 for power loss detection circuit 1003 (this may be a signal that indicates that the main 12V power has been disconnected and that power has switched to internal battery backup; it also may indicate that the forklift battery has been disconnected for charging; it also may allow for prioritization of critical uploads before power down and/or for initiation of a controlled power down or low-power state for main board 101);
Inter-Integrated Circuit (I2C) bus 1007 for connection to:
   Distance-measuring sensor(s) 1502, such as a Time-of-Flight (ToF) sensor, an ultrasonic sensor, a mmWave radar sensor, a lidar sensor, or the like (e.g., SparkFun Qwiic Mini ToF Imager VL53L5CX, available from SparkFun Electronics of Niwot, Colorado);
   Temperature sensor 1008 (e.g., TMP10x temperature sensor, available from Texas Instruments of Dallas, Texas);
   Status LED dimmer 1009 (e.g., AD5337 digital-to-analog converter (DAC), available from Analog Devices of Norwood, Massachusetts);
   LED GPIO expander 1010 (e.g., PCA9555 expansion device, available from NXP Semiconductors of Eindhoven, Netherlands);
   LED dimmable drivers 1011 capable of driving two pairs of LED arrays such as XLamp CXB1310, available from Cree LED of Research Triangle Park, North Carolina.

One skilled in the art will recognize that other parts and components may be used in addition to or instead of those listed above, and that other arrangements and architectures may be used.

### Scanner(s) 1501

As mentioned above, in various embodiments, apparatus 800 may include any number of scanner(s) 1501, some of which may be located within main unit 802 while others may optionally be located within auxiliary module(s) 801. Since main unit 802 and/or auxiliary module(s) 801 may be affixed to different locations on forklift 803, these multiple scanners 1501 may be situated and orientated so that they more effectively capture data and/or images (scans) of cargo and/or other items from different angles. Such an approach may yield more accurate and reliable data and/or images from which to extra important information about such cargo and/or other items. In an alternative embodiment, apparatus 800 may operate in conjunction with other scanner(s) 1501 that are not located on forklift 803.

In various embodiments, scanner(s) 1501 may be positioned at various locations on forklift 803, so that they can capture data and/or images for item(s) within a volume of interest, which may include an area wherein item(s) or pallet(s) loaded on the forklift may be situated. For example, in at least one embodiment, scanner(s) 1501 may be positioned so that it/they can scan the front, back, and/or side(s) of one or more items or other pallets loaded on forklift 803. Each pallet may contain any number of items.

In another embodiment, as described above, main unit 802 and/or auxiliary module(s) 801, each containing one or more scanner(s) 1501, may be affixed to backrest 804 of forklift 803, as described above.

In another embodiment, as described above, main unit 802 and/or auxiliary module(s) 801, may be affixed to columns 806 and/or crossbar 807 of forklift 803, as described above.

In at least one embodiment, scanner(s) 1501 may be positioned and oriented so that they are able to capture images of items loaded onto forks 805 of forklift 803. In at least one embodiment, scanner(s) 1501 may be situated so that their position is substantially adjacent to items loaded onto forks 805 of forklift 803.

In at least one embodiment, main unit 802 and/or auxiliary module(s) 801, each containing one or more scanner(s) 1501, may be of a size sufficiently small to fit between cab 808 of forklift 803 and the item(s) currently loaded on forklift 803.

In at least one embodiment, scanner(s) 1501 may be video capture devices configured to capture a video stream that is transmitted to cloud-based computing device 1605, for example via communications network 1606. In an alternative embodiment, scanner(s) 1501 may be image capture devices configured to capture still images that are transmitted to cloud-based computing device 1605.

### Lighting

In at least one embodiment, automatic lighting can be installed, which may be configured to automatically illuminate text, barcodes, labels, and/or other visual information that may be present on items within the volume of interest (i.e., items being carried by the forklift). Such automatic lighting may help to improve the quality of captured images and/or video streams. For example, in at least one embodiment, main unit 802 and/or auxiliary module(s) 801 may include one or more lamp(s) 1607 or other devices capable of providing illumination directed at cargo items to be scanned. In at least one embodiment, distance-measuring sensor(s) 1502 (if provided) may be used to control the automatic lighting, for example by automatically activating and deactivating lamp(s) 607 at appropriate times, so as to illuminate text, barcodes, labels, and/or other visual information only during active loading/unloading sessions. Lamp(s) 1607 may also be separate from main unit 802 or auxiliary module(s) 801.

### Additional Sensors

In at least one embodiment, any number of additional sensors may be affixed to forklift 803. For example, an accelerometer may be included, which may provide safety feedback for forklift operators and other personnel, for example by detecting excessive speed and providing appropriate alerts, and/or automatically stopping the forklift if an imminent collision or other unsafe condition is detected. As another example, distance-measuring sensor(s), depth sensor(s), and/or motion sensor(s) may be provided, to detect when an item is close to forklift 803 or loaded onto forklift 803; an example of such sensor is distance-measuring sensor(s) 1502, which may be any type of sensor for detecting proximity of objects, such as for example a Qwiic Time-of-Flight (ToF) sensor, an ultrasonic sensor, a mmWave radar sensor, a lidar sensor, or the like. Such detection may be used to automatically activate scanner(s) 1501 and/or lamp(s) 1607, since presence of an item on forklift 803 may indicate a suitable time for to attempt to visually scan and/or read optical information on the item. Similarly, data from such sensors may be used to indicate when scanner(s) 1501 and/or lamp(s) 1607 should be automatically deactivated, such as when the item is no longer loaded onto forklift 803. Automatically activating and/or deactivating scanner(s) 1501 in this manner may save battery usage and/or may conserve other resource usage.

In at least one embodiment, one or more sensors for detecting location data may be provided, to help determine where an item is located in real time. Location data may also be used to help identify locations where items should be replaced within the warehouse.

In at least one embodiment, data from scanner(s) 1501 and/or other sensor(s) may be used for additional purposes. For example, if scanner(s) and/or other sensor(s) detect the presence of a person, obstacle, safety hazard, or other item in front of forklift 803, an alert (such as a loud beep and/or visual alert) may automatically and immediately be output, and/or apparatus 800 may be configured to immediately apply brakes to stop the forklift from further movement.

### Critical Recording Period

In at least one embodiment, apparatus 800 may automatically determine a “critical recording period,” which is an optimal time period to capture images or otherwise obtain data such as visual images of item(s). For example, a critical recording period may include time periods during which forklift 803 is either a) approaching item(s) to be loaded, b) backing away from item(s) just after they have been unloaded, or c) in the process of loading or unloading item(s). The period during which item(s) is/are being loaded onto forklift 803 may be referred to as a “loading session”, and the period during which item(s) is/are being unloaded from forklift 803 may be referred to as an “unloading session”. Such time periods may be optimal for capturing visual images of item(s) because the item(s) is/are relatively close to scanner(s) 1501, but still far enough away to be sufficiently illuminated by lamp(s) 1607 for image capture.

In at least one embodiment, distance-measuring sensor(s) 1502 may be used to detect proximity of cargo item(s) and thereby determine when the critical recording period begins and ends; in at least one embodiment, scanner(s) 1501 and/or lamp(s) 1607 may be automatically activated at the beginning of the critical recording period, and may be automatically deactivated at the end of the critical recording period.

For example, video capture may automatically be initiated when forklift 803 is being used to actively load or unload item(s), and may automatically end when the loading/unloading operation is completed. In at least one embodiment, distance-measuring sensor(s) 1502 may be used to automatically determine start/end times of loading/unloading sessions. Such distance-measuring sensor(s) 1502 may be part of main unit 802 or auxiliary module 801, or may be separate. In at least one embodiment, distance-measuring sensor(s) 1502 may be installed, for example, adjacent to main unit 802 or auxiliary module(s) 801, or at any other suitable location on forklift 803 or external to forklift 803.

### Cloud-Based Computing Device 1605

In at least one embodiment, cloud-based computing device 1605 may receive image data (such as, for example, video clips) and/or other data collected by scanner(s) 1501, and may process such data, for example to identify item(s) being loaded or unloaded onto or off forklift 803. In at least one embodiment, data received from scanner(s) 1501 may be added to a main stack; processing of data in the main stack may take place in real-time or in a batched mode.

In at least one embodiment, as discussed above, data may be captured during loading sessions and/or unloading sessions. Apparatus 800 may be configured to automatically start capture (such as video capture) when such sessions begin, and to automatically stop capture when such sessions end. In at least one embodiment, cloud-based computing device 1605 may determine whether sufficient data was captured during the loading session. If sufficient data was captured during a loading session, cloud-based computing device 1605 may automatically send a signal to main unit 802, instructing scanner(s) 1501 not to attempt further data capture during the subsequent unloading session. Conversely, if sufficient data was not captured during the loading session, cloud-based computing device 1605 may automatically send a signal to main unit 802, instructing scanner(s) 1501 to attempt further data capture during the unloading session. Such analysis may also take place at main unit 802 itself, which may then direct scanner(s) 1501 at main unit 802 and/or module(s) 801 as to whether or not to attempt further data capture.

Once data from scanner(s) 1501 has been received at cloud-based computing device 1605 and processed as needed, software running at cloud-based computing device 1605 may perform detailed data analysis and may present the results to a user in the form of reports and the like.

In at least one embodiment, the data (such as the truncated video clips, still images, barcodes, and/or the like) may be made available to users via software running at cloud-based computing device 1605, which may show a dashboard that allows users to access various types of functionality and view various images, videos, data, and/or the like.

In at least one embodiment, software running at cloud-based computing device 1605 (or running locally at main unit 802 and/or any other component) may be configured to alert a user if any damage to any item(s) is detected based on images captured by scanner(s) 1501 and/or other sensor(s).

In at least one embodiment, the functionality described herein for cloud-based computing device 1605 may be implemented on main board 101. In alternative embodiments, it may be implemented in any other component(s), whether cloud-based, local, remote, and/or distributed. Cloud-based computing 1605 may communicate with main unit 802 via wireless communication interface 1604 and communications network 1606, for example to upload images and/or other data from main unit 802 to cloud-based computing device 1605.

### Method

In at least one embodiment, based on detection by distance-measuring sensor(s) 1502 that a loading or unloading session is commencing, main unit 802 may cause one or more lamp(s) 1607 to be activated, and may cause one or more scanner(s) 1501 to automatically begin capturing data (such as a video stream of cargo items being loaded or unloaded). Based on detection by distance-measuring sensor(s) 1502 that the loading/unloading session has been completed, main unit 802 may cause lamp(s) 1607 to be deactivated, and may cause scanner(s) 1501 to stop capturing data. The data (such as the video stream) may then be automatically transmitted to cloud-based computing device 1605 for automated reading and analysis, for example by barcode reading software and/or optical character recognition software. Alternatively, such automated reading and analysis may take place locally by another component of apparatus 800 which may be located on forklift 803 or elsewhere, such as for example main unit 802.

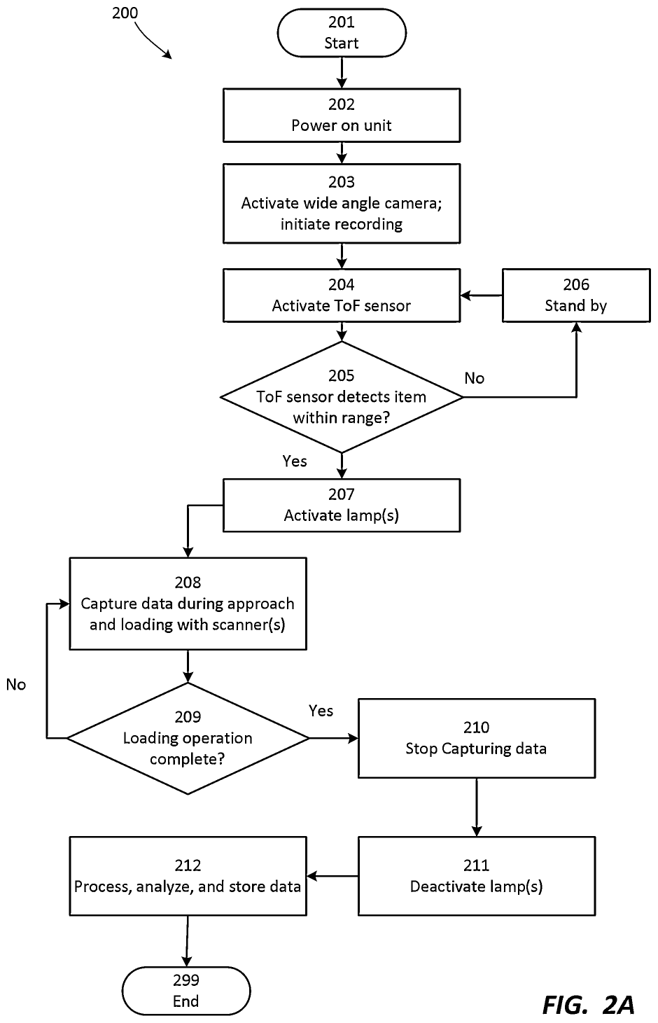

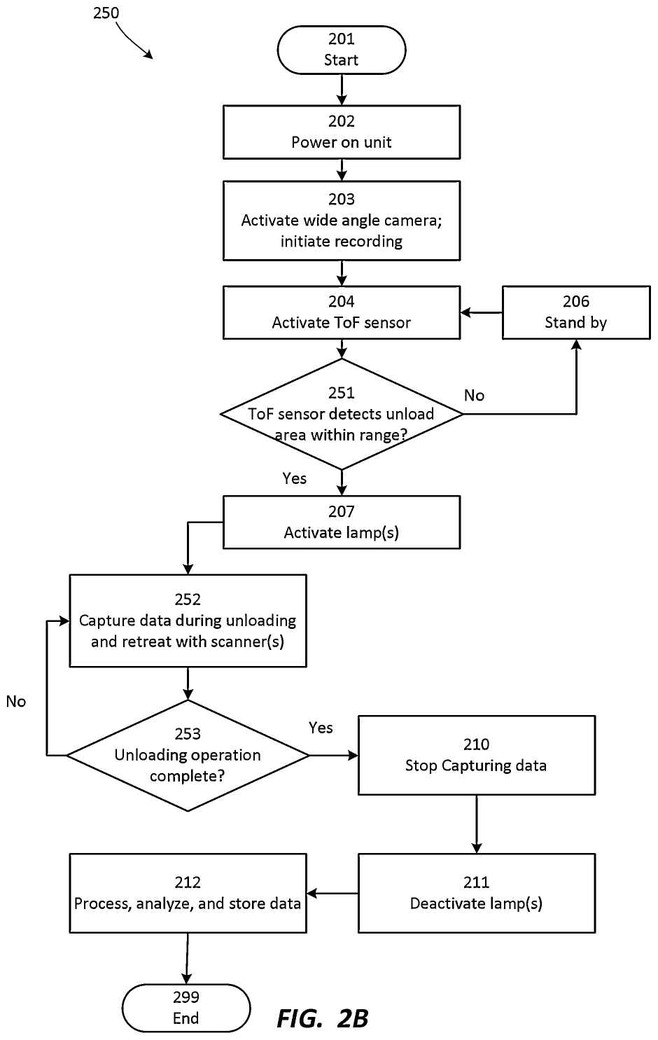

Referring now to FIG. 2A, there is shown a flowchart depicting an example of a method 200 for capturing cargo item data during a loading operation via forklift-based cargo scanning apparatus 800, according to one embodiment. The method begins 201 and main unit 802 may be powered on. Wide-angle image capture device 1503 may be activated 203 and may initiate recording, to provide context for data (such as image data) captured by scanner(s) 1501. Distance-measuring sensor(s) 1502, such as Time-of-Flight (ToF) or ultrasonic sensor, may be activated 204. When sensor(s) 1502 detect(s) 205 an item (such as a cargo item) within a specified range of scanner(s) 1501, a loading session may be determined to have commenced. If no item is within the specified range, apparatus 800 continues to stand by 206.

Once a loading session is determined to have commenced, main unit 802 may send a signal to cause lamp(s) 1607 to be automatically activated 207. Main unit 802 may also send a signal to cause scanner(s) 1501 to automatically begin capturing and recording 208 data, such as a video stream of the approach to the item and loading of the item onto forklift 803. In an alternative embodiment, scanner(s) 1501 may capture still images and/or nonvisual data, in addition to or instead of video streams.

In at least one embodiment, the system may determine that the loading operation is complete based on information from distance-measuring sensor(s) 1502, which may indicate that the pallet is fully loaded. Once the loading operation is complete 209, main unit 802 may send a signal to cause scanner(s) 1501 to stop 210 capturing data and to cause lamp(s) 1607 to be automatically deactivated 211. The data (such as the video stream) captured by scanner(s) 1501 may then be processed, analyzed, and stored 212, for example by transmitting it via wireless communication interface 1604 and communications network 1606 to cloud-based computing device 1605. Analysis of the data may include, for example, capturing and/or interpreting optical data such as text, machine-readable codes, and/or other identifiers, in order to identify cargo items and/or their destinations. Analysis of the data may further include determining whether there is any evidence of item damage. The method may then end 299.

Referring now to FIG. 2B, there is shown a flowchart depicting an example of a method 250 for capturing cargo item data during an unloading operation via forklift-based cargo scanning apparatus 800, according to one embodiment. The method begins 201 and main unit 802 may be powered on (if it is not already on). Wide-angle image capture device 1503 may be activated 203 and may initiate recording, to provide context for image data captured by scanner(s) 1501. Distance-measuring sensor(s) 1502, such as Time-of-Flight (ToF) or ultrasonic sensor, may be activated 204. When sensor(s) 1502 detect(s) 251 that an unload area is within range of scanner(s) 1501, an unloading session may be determined to have commenced. If no unload area is within the specified range, apparatus 800 continues to stand by 206.

In at least one embodiment, the system determines that an unload operation is about to begin based on data from sensor(s) 1502. For example, sensor(s) 1502 may detect that a pallet is moving away from backrest 804, indicating the beginning of an unloading session. Scanner(s) 1501 may begin capturing information when the pallet is within the optimal viewing area. Alternatively, sensor(s) 1502 may determine when the pallet is fully removed from forks 805, and then pull data from an immediately preceding time period (such as, for example, the five seconds just before the pallet was fully removed). The system may then select those images/data that are of the best quality among those recorded/captured.

Once an unloading session is determined to have commenced, main unit 802 may send a signal to cause lamp(s) 1607 to be automatically activated 207. Main unit 802 may also send a signal to cause scanner(s) 1501 to automatically begin capturing and recording 252 data, such as a video stream of the unloading of the item off forklift 803 and of the retreat from the unload area. In an alternative embodiment, scanner(s) 1501 may capture still images and/or nonvisual data, in addition to or instead of video streams.

Once the unloading operation is complete 253, main unit 802 may send a signal to cause scanner(s) 1501 to stop 210 capturing data and to cause lamp(s) 1607 to be automatically deactivated 211. The data (such as the video stream) captured by scanner(s) 1501 may then be processed, analyzed, and stored 212, for example by transmitting it via wireless communication interface 1604 and communications network 1606 to cloud-based computing device 1605. In at least one embodiment, the system may determine that an unloading operation is complete based on data captured by sensor(s) 1502, for example based on a determination that the pallet is fully unloaded from forks 805. Analysis of the data may include, for example, capturing and/or interpreting optical data such as text, machine-readable codes, and/or other identifiers, in order to identify cargo items and/or their destinations. Analysis of the data may further include determining whether there is any evidence of item damage. The method may then end 299.

### Additional Variations

In at least one embodiment, apparatus 800 may collect and/or generate data for performance analytics. Such data may be used, for example, for analyzing text data ingestion, and for facilitating damage inspection, speed, and safety verification, and/or the like.

In at least one embodiment, apparatus 800 may automatically generate output to inform forklift operators where to pick items up and where to drop them off, in the context of a warehouse or in other contexts such as on a truck. Such output may include, for example, audio output played over speaker(s) 1603 and/or visual output shown on display screen 112 and/or via indicator lights.

In at least one embodiment, apparatus 800 may automatically collect data about a warehouse or other location, to create a map that can be used to track freight locations, provide locations to pick up and put away items, and/or help operators navigate forklifts.

In at least one embodiment, apparatus 800 may collect data about damaged freight to provide real-time feedback to customers and inform them of changes in shipments.

In at least one embodiment, apparatus 800 may provide dimensional and weight data for freight being transported to a customer. Image data from scanner(s) 1501, along with other data such as data from scale 1601 and/or other scanners, may be used for generating such dimensional and weight data.

In at least one embodiment, forklift operation may be automated, and data from scanner(s) 1501 and/or other sensor(s) may be used as input for such automated operation. For example, forklift 803 may be configured to automatically move item(s) to particular location(s) within a warehouse, and/or to sort item(s) in a particular manner, based on optical data read from labels on item(s).

In at least one embodiment, forklift 803 may be configured to automatically slow down when item label(s) and/or packaging is to be read, so as to improve the likelihood of satisfactory image capture.

In at least one embodiment, apparatus 800 may provide real-time location tracking, for example via Simultaneous Localization and Mapping (SLAM). This may be accomplished via any or all of the following, either singly or in any combination:
GPS;
Stereo camera;
Mono camera;
IMU;
RF beaconing (WiFi, Ultra-wideband tracking (UWB), Bluetooth, and/or the like.

For any of the above approaches, a sensor may be provided within main unit 802 or externally (communicating with main unit via any suitable wired or wireless communication means, including for example WiFi, Ethernet, USB, and/or the like). Cameras may be placed in opposite-facing directions for SLAM/location tracking of forklift 803. Cameras may also be placed in different directions to track real-time inventory of items in the warehouse. In at least one embodiment, labels may be read in all directions around forklift 803, and need not be forward facing toward forks 805.

One skilled in the art will recognize that other variations and features are possible.

The present apparatus and method have been described in particular detail with respect to possible embodiments. Those of skill in the art will appreciate that the apparatus and method may be practiced in other embodiments. First, the particular naming of the components, capitalization of terms, the attributes, data structures, or any other programming or structural aspect is not mandatory or significant, and the mechanisms and/or features may have different names, formats, or protocols. Further, the apparatus may be implemented via a combination of hardware and software, or entirely in hardware elements, or entirely in software elements. In addition, the particular division of functionality between the various components described herein is merely exemplary, and not mandatory; functions performed by a single component may instead be performed by multiple components, and functions performed by multiple components may instead be performed by a single component.

Reference in the specification to “one embodiment” or to “an embodiment” means that a particular feature, structure, or characteristic described in connection with the embodiments may be included in at least one embodiment. The appearances of the phrases “in one embodiment” or “in at least one embodiment” in various places in the specification are not necessarily all referring to the same embodiment.

Various embodiments may include any number of apparatuses, devices, components, and/or methods for performing the above-described techniques, either singly or in any combination. Another embodiment includes a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps may be those requiring physical manipulations of physical quantities. Usually, though not necessarily, these quantities take the form of electrical, magnetic or optical signals capable of being stored, transferred, combined, compared and otherwise manipulated. It may be convenient at times, principally for reasons of common usage, to refer to these signals as bits, values, elements, symbols, characters, terms, numbers, or the like. Furthermore, it may also be convenient at times to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions may be embodied in software, firmware and/or hardware, and when embodied in software, may be downloaded to reside on and be operated from different platforms used by a variety of operating systems.

The present document also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, DVD-ROMs, magnetic-optical disks, read-only memories (ROMs), random access memories (RAMs), EPROMS, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the apparatus and method are not described with reference to any particular programming language. It will be appreciated that a variety of programming languages may be used to implement the teachings described herein, and any references above to specific languages are provided for disclosure of enablement and best mode.

Accordingly, various embodiments include software, hardware, and/or other elements for controlling a computer system, computing device, or other electronic device, or any combination or plurality thereof. Such an electronic device can include, for example, a processor, an input device (such as a keyboard, mouse, touchpad, track pad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the described apparatus and method include: a mobile phone, personal digital assistant, smartphone, kiosk, server computer, enterprise computing device, desktop computer, laptop computer, tablet computer, consumer electronic device, or the like. An electronic device may use any operating system such as, for example and without limitation: Linux; Microsoft Windows, available from Microsoft Corporation of Redmond, Washington; MacOS, available from Apple Inc. of Cupertino, California; iOS, available from Apple Inc. of Cupertino, California; Android, available from Google, Inc. of Mountain View, California; and/or any other operating system that may be adapted for use on the device.

While a limited number of embodiments have been described herein, those skilled in the art, having benefit of the above description, will appreciate that other embodiments may be devised. In addition, it should be noted that the language used in the specification has been principally selected for readability and instructional purposes, and may not have been selected to delineate or circumscribe the subject matter. Accordingly, the disclosure is intended to be illustrative, but not limiting, of scope.

What is claimed is:

1. A mobile carrier based apparatus for capturing information about physical items, comprising:
a mobile carrier; and
at least one scanner affixed to the mobile carrier and adapted to automatically capture information about at least one physical item during at least one of a loading session and an unloading session.

2. The apparatus of claim 1, further comprising:
a communication interface, adapted to transmit the captured information to a cloud-based computing device.

3. The apparatus of claim 1, wherein:
each scanner comprises at least one of an image capture device and a video capture device; and
the information about each physical item comprises at least one selected from the group consisting of:
at least one image depicting the at least one physical item; and
at least one video stream depicting the at least one physical item.

4. The apparatus of claim 1, wherein the information about the at least one physical item comprises at least one image of at least one visual marking on the physical item.

5. The apparatus of claim 4, wherein the at least one visual marking comprises at least one selected from the group consisting of:
text; and
a machine-readable code.

6. The apparatus of claim 1, wherein the information about the at least one physical item comprises at least one image of at least one visual marking on a label affixed to the physical item.

7. The apparatus of claim 1, wherein:
the mobile carrier comprises a forklift; and
each physical item comprises a cargo item.

8. The apparatus of claim 7, wherein:
the forklift comprises a first column, a second column, and a crossbar; and
each scanner is affixed to at least one of the first column, the second column, and the crossbar of the forklift.

9. The apparatus of claim 7, wherein:
the forklift comprises a backrest; and
at least one scanner is affixed to backrest of the forklift.

10. The apparatus of claim 1, further comprising:
at least one lamp affixed to the mobile carrier and adapted to automatically illuminate the at least one physical item during at least one of the loading session and the unloading session.

11. The apparatus of claim 10, wherein:
the mobile carrier comprises a forklift comprising a first column, a second column, and a crossbar;
each scanner is affixed to at least one of the first column, the second column, and the crossbar of the forklift; and
each lamp is affixed to at least one of the first column, the second column, and the crossbar of the forklift.

12. The apparatus of claim 10, wherein:
the mobile carrier comprises a forklift comprising a first column, a second column, and a crossbar;
the at least one scanner comprises at least a first scanner affixed to the crossbar of the forklift, and at least one additional scanner affixed to one of the columns of the forklift; and
each lamp is affixed to one of the columns of the forklift.

13. The apparatus of claim 10, further comprising:
a main unit affixed to a first location on the mobile carrier; and
an auxiliary unit affixed to a second location on the mobile carrier;
wherein:
the at least one scanner is located within the main unit; and
the at least one lamp is located within the auxiliary unit.

14. The apparatus of claim 13, wherein:
the mobile carrier comprises a forklift comprising a first column, a second column, and a crossbar;
the main unit is affixed to at least one of the first column, the second column, and the crossbar of the forklift; and
each auxiliary unit is affixed to at least one of the first column, the second column, and the crossbar of the forklift.

15. The apparatus of claim 13, wherein the main unit is configured to automatically control operation of the lamp located within the auxiliary unit.

16. The apparatus of claim 13, further comprising:
a distance-measuring sensor, adapted to detect proximity of the at least one physical item, and to determine a beginning and ending of at least one of the loading session and the unloading session; and
a control unit, communicatively coupled to the distance-measuring sensor, adapted to:
automatically activate the at least one lamp and initiate information capture on the at least one scanner, upon a determination that at least one of the loading session and the unloading session is commencing; and
automatically deactivate the at least one lamp and stop information capture on the at least one scanner, upon a determination that at least one of the loading session and the unloading session is ending.

17. The apparatus of claim 10, further comprising:
a main unit affixed to a first location on the mobile carrier; and
an auxiliary unit affixed to a second location on the mobile carrier;
wherein:
the at least one scanner comprises:
at least one scanner located within the main unit; and
at least one scanner located within the auxiliary unit; and
the at least one lamp is located within the auxiliary unit.

18. The apparatus of claim 17, wherein the main unit is configured to automatically control operation of the scanner located within the auxiliary unit and the lamp located within the auxiliary unit.

19. The apparatus of claim 17, further comprising:
a distance-measuring sensor, adapted to detect proximity of the at least one physical item, and to determine a beginning and ending of at least one of the loading session and the unloading session; and
a control unit, communicatively coupled to the distance-measuring sensor, adapted to:
automatically activate the at least one lamp and initiate information capture on the at least one scanner, upon a determination that at least one of the loading session and the unloading session is commencing; and
automatically deactivate the at least one lamp and stop information capture on the at least one scanner, upon a determination that at least one of the loading session and the unloading session is ending.

20. The apparatus of claim 1, further comprising:
a main unit affixed to a first location on the mobile carrier; and
an auxiliary unit affixed to a second location on the mobile carrier;
wherein the at least one scanner comprises:
at least one scanner located within the main unit; and
at least one scanner located within the auxiliary unit.

21. The apparatus of claim 1, further comprising:
a distance-measuring sensor, adapted to detect proximity of the at least one physical item, and to determine a beginning and ending of at least one of the loading session and the unloading session; and
a control unit, communicatively coupled to the distance-measuring sensor, adapted to:
automatically initiate information capture on the at least one scanner upon a determination that at least one of the loading session and the unloading session is commencing; and
automatically stop information capture on the at least one scanner upon a determination that at least one of the loading session and the unloading session is ending.

22. The apparatus of claim 1, further comprising:
a wide-angle image capture device affixed to the mobile carrier, and adapted to automatically capture at least one wide-angle visual representation of an environment including the at least one physical item.

23. A method for capturing information about physical items, comprising:
automatically detecting, via a distance-measuring sensor affixed to a mobile carrier, proximity of at least one physical item to determine a beginning and ending of at least one of a loading session and an unloading session;
upon a determination that at least one of the loading session and the unloading session is commencing, automatically initiating capture of information about the at least one physical item using at least one scanner affixed to the mobile carrier; and
upon a determination that at least one of the loading session and the unloading session is ending, automatically stopping capture of information about the at least one physical item.

24. The method of claim 23, further comprising:
automatically transmitting, via a communication interface, the captured information to a cloud-based computing device.

25. The method of claim 23, wherein:
each scanner comprises at least one of an image capture device and a video capture device; and
the information about each physical item comprises at least one selected from the group consisting of:
at least one image depicting the at least one physical item; and
at least one video stream depicting the at least one physical item.

26. The method of claim 23, wherein the information about the at least one physical item comprises at least one image of at least one visual marking on the physical item.

27. The method of claim 26, wherein the at least one visual marking comprises at least one selected from the group consisting of:
text; and
a machine-readable code.

28. The method of claim 23, wherein the information about the at least one physical item comprises at least one image of at least one visual marking on a label affixed to the physical item.

29. The method of claim 23, wherein:
the mobile carrier comprises a forklift; and
each physical item comprises a cargo item.

30. The method of claim 23, further comprising:
upon the determination that at least one of the loading session and the unloading session is commencing, automatically activating at least one lamp affixed to the mobile carrier to automatically illuminate the at least one physical item; and
upon the determination that at least one of the loading session and the unloading session is ending, automatically deactivating the at least one lamp.

31. The method of claim 23, further comprising:
automatically capturing, via wide-angle image capture device affixed to the mobile carrier, at least one wide-angle visual representation of an environment including the at least one physical item.
